(19) United States
(12) Patent Application Publication
(10) Pub. No.: US 2014/0241846 A1
(43) Pub. Date: Aug. 28, 2014

(54) PICK UP TIP ASSEMBLY

(71) Applicant: TEXAS INSTRUMENTS INCORPORATED, Dallas, TX (US)

(72) Inventor: Mohd Nuruddin Mohd Zairi, Kuala Lumpur (MY)

(73) Assignee: TEXAS INSTRUMENTS INCORPORATED, Dallas, TX (US)

(21) Appl. No.: 13/781,464

(22) Filed: Feb. 28, 2013

(51) Int. Cl. B25J 15/06; B25J 11/00

(52) U.S. Cl. CPC B25J 15/0683; B25J 11/00
USPC 414/752.1; 414/800; 294/183; 294/189

(57) ABSTRACT

A pick up tip assembly that includes a plurality of overlapping petals defining a petal enclosure having a distal end opening A displaceable member is engagable with the plurality of petals and the size of the distal end opening is adjustable by displacement of the displaceable member.

### BACKGROUND

Microelectronics are ubiquitous in the modern world. Microelectronics include integrated circuit (IC) chips, leadframes, passive circuit components, heat sinks, electronic substrates and various other parts and components. Many microelectronic components have dimensions of a few millimeters or less. Such small devices must be picked up and moved from place to place during production thereof. Also, such components must typically be attached to other components again necessitating the movement of these tiny objects from one location to another. So called “pick and place” machines or tools are the primary means for picking up and moving such small components. Such pick and place machines are typically paired with machine vision systems. Pick and place machines often use pick up tips that comprise a small resilient member having a central hole therein that is in fluid communication with a vacuum source. To pick up a component, the tip is placed in contact with a surface of the component. A vacuum is then applied, which holds the component to the tip. The tip is then moved by the pick and place machine to a desired location. At the desired location, the vacuum is removed allowing the component to decouple from the tip. In order to be effective, the size of the hole in the pick up tip must be an appropriate size for the object that is to be picked up. Normally, the size of the hole is somewhat smaller than the engaged surface of the object. Pick and place machines are expensive. It is therefore often desirable to be able to use a pick and place machine to displace different types and sizes of microelectronic objects. One way of doing this is to provide a separate pick up tip for each different type or different sized object that is to be moved. Thus a pick and place machine may have different sized tips mounted thereon depending upon the current size or type of object that is to be picked up.

### BRIEF DESCRIPTION OF THE DRAWINGS

FIG. 1 is an exploded side elevation view of an adjustable pick up tip assembly 10.

FIG. 2 is a cross sectional side elevation view of the adjustable pick up tip assembly of FIG. 1 in an operating state at which the tip opening is at a maximum diameter.

FIG. 3 is a cross sectional side elevation view of the adjustable pick up tip assembly of FIG. 1 in a second operating state at which the tip opening is at a minimum diameter.

FIG. 4 is a bottom plan view of a distal end portion of the pick up tip of FIG. 2.

FIG. 5 is a bottom plan view of a distal end portion of the pick up tip of FIG. 3.

FIG. 6 is a partial isometric view of two overlapping petals of the pick up tip of FIG. 1.

FIG. 7 is an isometric view of a single petal.

FIG. 8 is a schematic drawing of a pick and place machine having an adjustable pick up tip such as shown in FIGS. 1-5.

FIG. 9 is a block diagram of a method of picking and placing a component.

### DETAILED DESCRIPTION

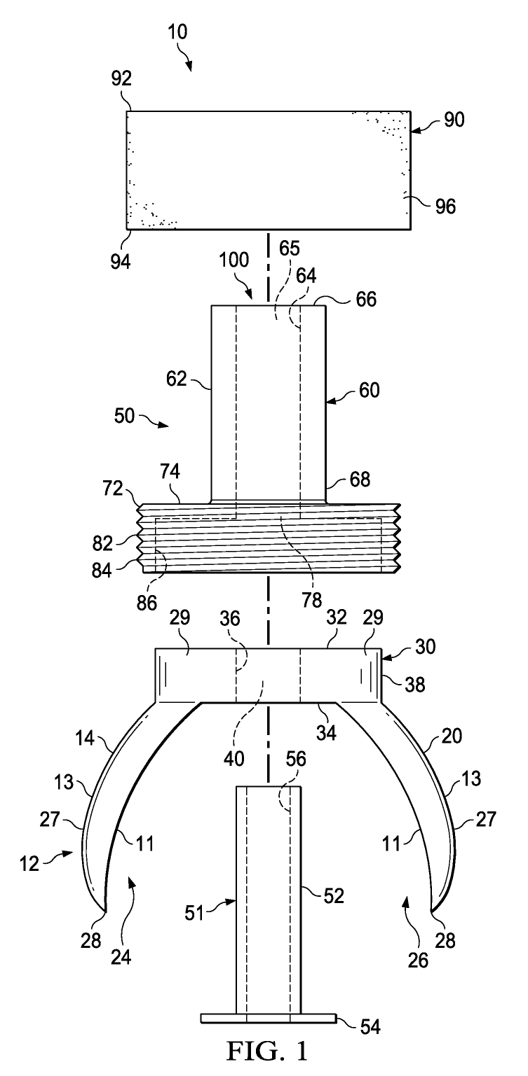

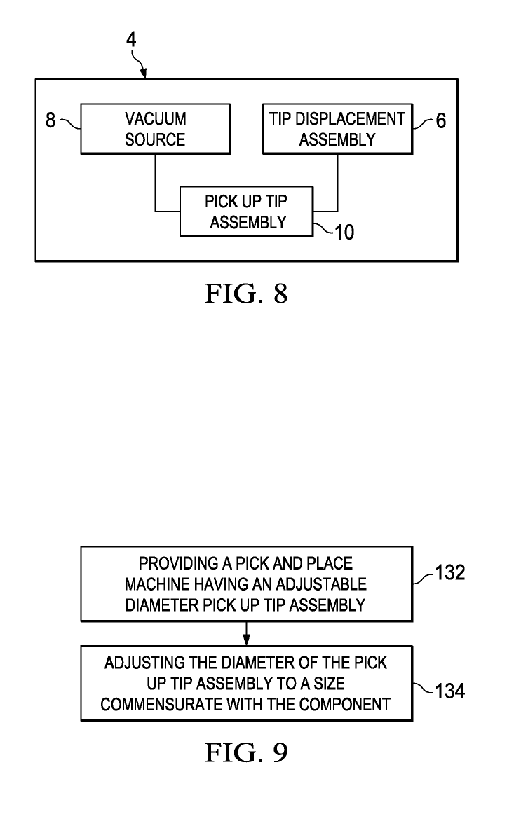

This specification, in general, discloses a pick up tip assembly 10, FIGS. 1-3, which may be a component of a pick and place machine 4, FIG. 8. The pick up tip assembly 10 includes a plurality of overlapping petals 12 defining a petal enclosure 24 with a distal end (tip) opening 26. A displaceable member, such as, for example a ring 90, is engagable with the plurality of petals 12. The size of the distal end opening 26 is adjustable by displacement of the displaceable member 90. Having thus generally described a pick up tip assembly 10, the construction and operation of the pick up tip assembly 10 will now be described in detail.

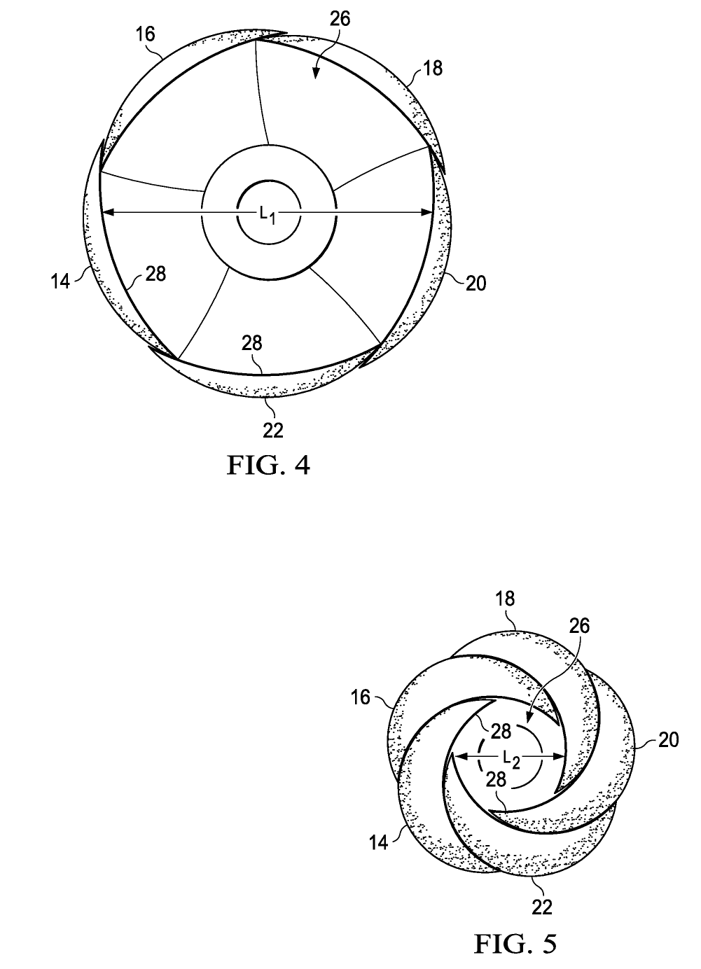

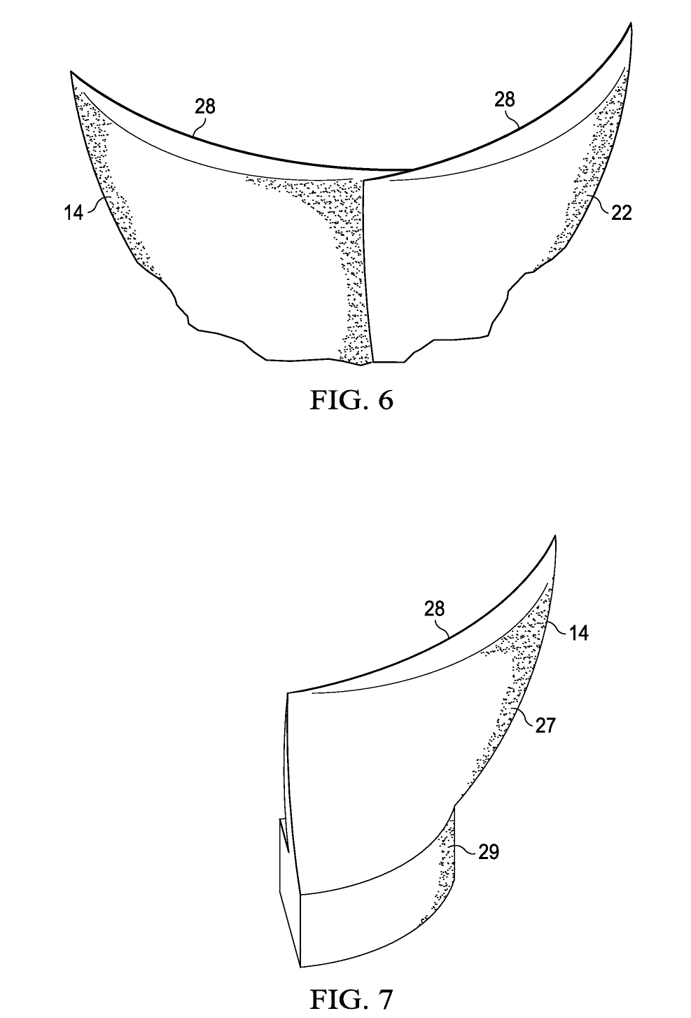

FIG. 1 is an exploded side elevation view of an adjustable pick up tip assembly 10. The pick up tip assembly 10 may, as shown in FIG. 8, be a component of a pick and place machine 4. The pick and place machine 4 may have a conventional tip displacement assembly 6 operatively associated with the tip assembly 10 for moving the pick up tip assembly 10 between desired locations associated with picking up an object and placing the object. A conventional vacuum source 8 may be operably associated with the pick up tip assembly 10 and is used for selectively applying a vacuum thereto. The tip assembly 10 has a plurality of petals 12, so named because they resemble the petals of a flower in both shape and function. Each petal has a front surface 11 and a back surface 13 and may be made from a resilient material such as rubber or plastic. The plurality of petals 12 comprises petals 14, 16, 18, 20 and 22 as best shown in FIGS. 4 and 5. An individual petal 14 is shown in FIG. 7. Each petal has a petal body 27 with a petal base 29 at one end (the proximal end) and a petal tip portion 28 at the other end (the distal end). The petal base 29 may be integrally formed with the rest of the petal 14 or may be a separate member that is fixedly attached to a bottom portion of the petal 14. The petal tip portions 28 may each have a generally saddle seat shape. The plurality of petals 12 overlap one another in sealing relationship to form a petal enclosure 24 defined by portions of the front surfaces 11 of the petals 12. The petal enclosure 24 has a circular distal end opening 26 defined by the distal end portions (tip portions) 28 of the petals 12. The petals 12 may overlap proceeding in a first direction as illustrated in the embodiment of FIG. 4 or in a second direction as illustrated in the embodiment of FIG. 5. (For illustrative purposes, only the tip portions 28 of the petals 12 are shown in FIGS. 4 and 5.) As further shown by FIG. 1, the tip assembly 10 includes an annular petal housing 30 that comprise an annular top wall 32, an annular vertically extending inside wall 36 that defines a housing central hole 40 and an annular vertically extending outside wall 38. Each of the petal base portions 29 are positioned within the annular petal housing 30.

The petal housing 30 may be mounted on a petal housing support assembly 50. The petal housing support assembly 50 may include a tubular plug member 51 comprising a tubular side wall 52 having an annular flange 54 mounted at the bottom thereof. The tubular wall 52 defines a cylindrical cavity 56, which is a fluid passageway that communicates with the vacuum supply 8. The annular flange 54 engages the base portions 29 of the petals 12, holding them in nonmoving engagement against the annular top wall 32. The petal housing support assembly 50 may also include a shank body 60 that includes an upper tubular member 62 with an inner side wall 64 that defines a central cylindrical cavity 65. Cavity 65 is sized to closely slidingly receive tubular plug member 51 therein. The upper tubular member 62 has an upper end 66 and a lower end 68. Attached to the lower end 68 is a lower member 72. The lower member 72 has a laterally extending top wall portion 74 having a central opening 78 therein which is an extension of the cylindrical cavity 65 in the upper tubular member 62. The lower member 72 adjacent to opening 78 may be welded or otherwise rigidly attached to the lower end 68 of the upper tubular member 62. The lower member 72 has a vertically and circumferentially extending wall portion 82, the interior of which is of a size adapted to receive the annular petal housing 30 therein. The flange 54 engages the bases 29 of the petals 12 urging them against the wall 32 of the annular petal housing 30 and thus vertically supports the petal housing 30 within the enclosure formed by the circumferentially extending wall portion 82. The tubular wall 52 of the tubular plug member 51 may have threads (not shown) thereon which engage matching threads (not shown) on the inner wall 64 of upper shank member 62, or the plug member 51 may be otherwise attached to the inner wall 64 of upper member 62 as by a press fit or by other means. The vertically and circumferentially extending wall portion 82 of the lower member 72 of the shank body 60 may have a threaded outer surface 84. The inner surface 86 of wall portion 82 is adapted to receive the annular petal housing wall 38 in close circumscribing relationship therewith.

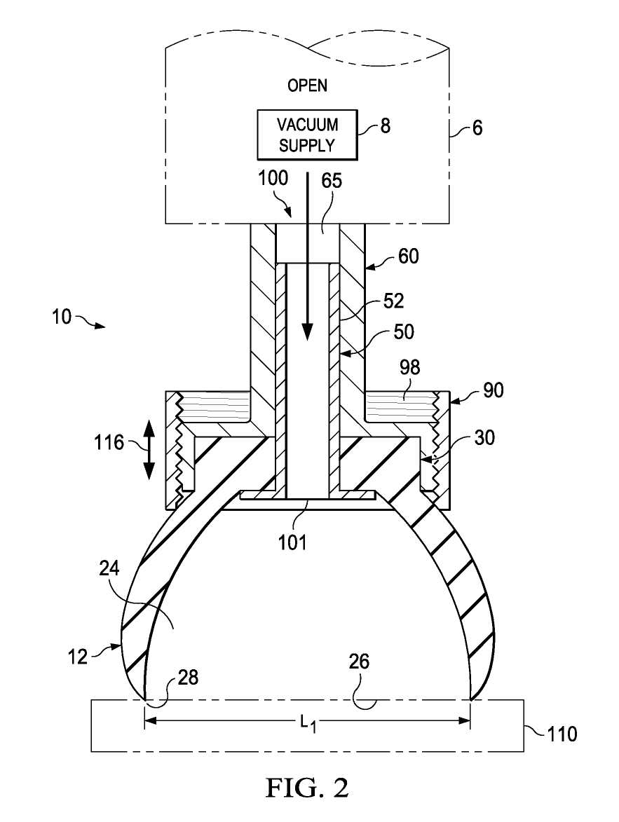

A threaded ring 90 has a top edge 92, a bottom edge 94 and an outer wall 96 which may be roughened to facilitate hand rotation of threaded ring 90. Threaded ring 90 has a threaded inner wall 98, FIG. 2, which is adapted to threadingly mate with the threaded outer surface 84 of the shank body lower member 72.

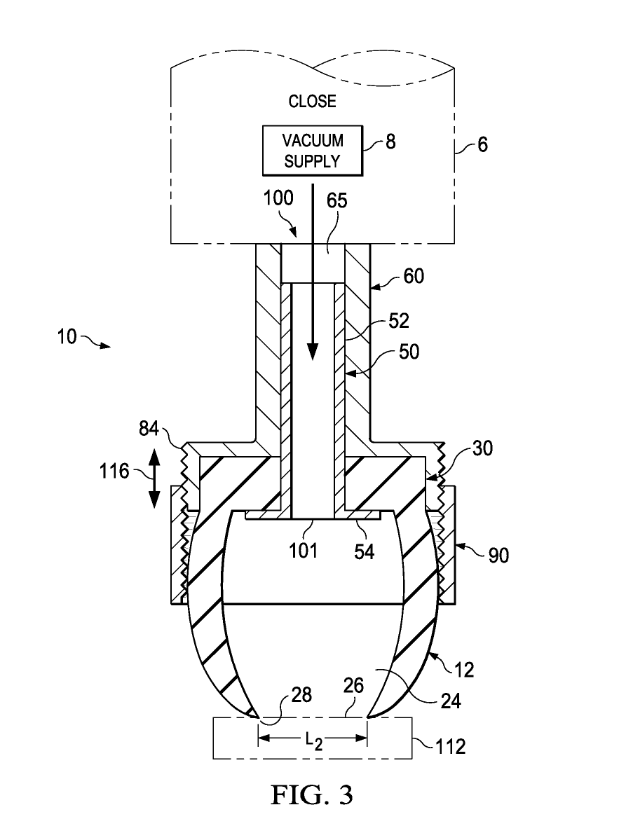

It will be seen from the above description that the central cylindrical cavity 65 of the shank body upper member 62, the opening 78 in the lower member 72, and the cylindrical cavity 56 in the tubular plug member 51 provide a continuous fluid passageway 100 from the upper end 66 at the shank member into the enclosure 24 formed by the plurality of petals 12. This continuous fluid passageway 100 is in fluid communication with a vacuum source 8, shown schematically in FIGS. 2, 3 and 8, and has a vacuum orifice 101 at the proximal end of the petal enclosure 24. When a part, e.g., 110, FIG. 2 or 112, FIG. 3 is to be picked and placed, it is engaged by the tip portions 28 of the petals 12. (Part 110 or 112 may also be referred to herein as “component” or “item” or “object”110 or 112.) The part 110 or 112 thus covers the circular opening 26 defined by the petal tips 28 such that the petal enclosure 24 becomes a sealed enclosure. Vacuum/suction force applied through fluid passageway 100 thus holds the part 110 or 112 against the plurality of petal tip portions 28 until the vacuum is released. The material from which the petals 12 are formed is sufficiently stiff that the petals 12 do not collapse when the vacuum is applied to the petal enclosure 24. This material is also sufficiently resilient that the overlapping surfaces of the petals 12 form an air tight seal in response to application of vacuum to the enclosure 24.

The plurality of petals 12, when no external force from ring 90 is applied thereto, assume the shape illustrated in FIG. 2. In this position, the dimension L₁ between diametrically opposed tip portions 28 is at its maximum. This position is used to engage relatively larger items 110 since the vacuum may be applied over a large portion of the face of the larger item 110. The larger the area to which vacuum is applied, the greater the amount of total force that is applied to the item 110. The threads on the inner walls of ring 90 and the outer wall 84 of lower member 72 enable the ring 90 to be moved vertically 116 by rotating the ring 90. Thus, rotation of the ring 90 in a first direction causes the ring 90 to move axially upwardly toward the position illustrated in FIG. 2. Rotation in the opposite direction causes the ring 90 to move axially downwardly towards its lowest position illustrated in FIG. 3. In the highest position illustrated in FIG. 2, in one embodiment, the ring 90 applies no force to the plurality of petals 12. In this situation, the petals 12, due to their resiliency, and the orientation of the petal base 29 in the annular petal housing 30 move to their widest spacing. In the position illustrated in FIG. 3, the ring 90 is at its lowermost point and has urged the petals 12 inwardly to their inward most position where the diameter of the opening 26 is the distance L₂. The mating thread relationship between the inside threads on the ring 90 and threads on the outer surface 84 hold/lock the ring 90 at the vertical height associated with the current rotated position of the ring 90. In other words, the ring 90 does not moved up or down except in response to rotation of the ring 90 with respect to the wall 84. The petals 12 may of course be moved to intermediate positions at which the diameter L of the opening 26 is between the maximum diameter L₁ and the minimum diameter L₂. In a typical use situation, a diameter L of the opening 26 is selected that is greater than about half the minimum dimension of the top surface of the part 110 or 112 that is to be picked up. Of course, the actual weight of the part 110, 112 may influence this relationship. The greater the area of the opening 26, the greater the total amount of suction force that the tip assembly 10 will apply to the part 110 or 112. Thus, a heavier weight can be picked up by the tip assembly 10 when it has a larger opening 26 than when it has a smaller opening 26. The adjustable pick up tip assembly 10 as previously mentioned is adapted to be mounted on a displacement assembly 6 of a pick and place machine 4 shown schematically in FIGS. 2, 3 and 7. The pick and place machine 4 may move the tip assembly 10 in a conventional manner, i.e., laterally, longitudinally, and vertically and may also rotate the tip assembly 10 about one or more axes.

A method of picking and placing a part, is shown in the block diagram of FIG. 9. The method may include, as shown at 132, providing a pick and place machine having an adjustable diameter pick up tip assembly and, as shown at 134, adjusting the diameter of an opening in the pick up tip assembly to a size commensurate with the part. In another embodiment the method may include the aforementioned steps and may also include applying a vacuum to the pick up tip assembly; moving the pick up tip assembly and the part to a predetermined location; and removing the vacuum from the pick up tip assembly. In yet another embodiment of the method the step of adjusting the diameter of the opening of the pick up tip assembly may comprise engaging outer surfaces of a plurality of petals with a ring and moving the ring so as to urge tip portions of the petals in a preselected direction.

Although certain embodiments of the structure of an adjustable pick up tip assembly, as well as the use thereof, have been disclosed in detail herein, various other embodiments thereof will become obvious to those skilled in the art after reading this disclosure. It is intended that the claims appended hereto be construed broadly to cover all such alternative embodiments except to the extent limited by the prior art.

What is claimed is:

1. A pick up tip assembly comprising:
a plurality of petals defining a petal enclosure with a distal end opening;
a displaceable member engagable with said plurality of petals; and
wherein the size of said distal end opening is adjustable by displacement of said displaceable member.

2. The assembly of claim 1 wherein each of said petals has a front surface and a back surface and wherein said front surfaces of said plurality of petals defines said petal enclosure.

3. The assembly of claim 2 wherein each of said petals has a tip portion and wherein said distal end opening is defined by said petal tip portions.

4. The assembly of claim 2 wherein said displaceable member engages said back surfaces of said petals.

5. The assembly of claim 1 wherein said displaceable member is axially displaceable.

6. The assembly of claim 1 wherein said displaceable member is rotatably displaceable.

7. The assembly of claim 5 wherein said displaceable member is axially displaceable by rotation of said displaceable member.

8. The assembly of claim 1 wherein said plurality of petals comprise a plurality of resilient petals.

9. The assembly of claim 1 further comprising a housing, a portion of each of said plurality of petals being mounted in said housing.

10. The assembly of claim 9, said housing comprising an annular housing.

11. The assembly of claim 9, said plurality of petals each having a base portion mounted in said annular housing.

12. The assembly of claim 1 wherein said petal enclosure is connected by a fluid passageway with a vacuum source.

13. The assembly of claim 12 wherein an orifice of said fluid passageway is located at a proximal end of said enclosure.

14. The assembly of claim 1 wherein said petals are positioned in overlapping sealing relationship.

15. The assembly of claim 9 wherein said displaceable member is a threaded ring and wherein said housing comprises threads engagable with said threaded ring.

16. A method of picking and placing a component comprising:
providing a pick and place machine having a pick up tip assembly; and
adjusting the diameter of an opening of the pick up tip assembly to a size commensurate with the component.

17. The method of claim 16 further comprising:
applying a vacuum to the pick up tip assembly;
placing the pick up tip in engagement with the component;
moving the pick up tip assembly and the component to a predetermined location; and
removing the vacuum from the pick up tip assembly.

18. The method of claim 16 wherein adjusting the diameter of the pick up tip assembly comprises:
engaging outer surfaces of a plurality of petals with a ring; and
moving the ring so as to urge tip portions of the petals in a preselected direction.

19. A pick and place machine for picking and placing items of different sizes comprising:
a) a vacuum source;
b) an adjustable pick up tip assembly in fluid communication with said vacuum source and having a distal end opening that is selectively adjustable and lockable in a plurality of different sizes commensurate with said different sizes of said items to be picked and placed; and
c) a displacement assembly operably connected to the pick up tip assembly that selectively displaces the pick up tip assembly.

20. The pick and place tool of claim 19 wherein said adjustable pick up tip comprises:
a plurality of resilient, overlapping petals, each having a base portion, a tip portion, a first surface and a second surface opposite the first surface and arranged to form a petal enclosure having an opening at a first end of said enclosure formed by said petal tip portions;
an annular petal housing in which said bases of said plurality of petals are mounted, said housing comprising an opening in fluid communication with said petal enclosure;
a support assembly supporting said housing and having a fluid passage therein in fluid communication with said opening in said housing; and
a vertically displaceable ring engagable with said second surfaces of said plurality of petals and co-acting therewith to selectively increase or decrease the diameter of said opening in said first end of said petal enclosure;
and wherein said plurality of resilient, overlapping petals comprise:
a first operating position in which said ring applies a lowest inwardly directed force to said petals and in which said opening in said first end of said petal enclosure formed by said petal tip portions has a maximum diameter;
a second operating position in which said ring applies a highest inwardly directed force to said petals and in which said opening in said first end of said petal enclosure formed by said petal tip portions has a minimum diameter; and
at least one intermediate operating position in which said ring applies an intermediate inwardly directed force to said petals and in which said first opening in said petal enclosure formed by said petal tip portions has a diameter between said maximum and minimum diameters; and
wherein said ring comprises a threaded inner wall and said support assembly comprises a threaded outer wall threadingly engaged with said threaded inner wall of said ring and wherein said ring is selectively vertically displaceable between said operating positions by rotation of said ring and wherein said ring is lockable at any selected one of said operating positions by co-action between said threads thereon and said threads on said support assembly.
